(19) United States
(12) Patent Application Publication
(10) Pub. No.: US 2005/0076997 A1
(43) Pub. Date: Apr. 14, 2005

(54) Method and device for the production of tubular films

(76) Inventor: Fritz Brinkmann, Scheyern (DE)

Correspondence Address: JORDAN AND HAMBURG LLP, 122 EAST 42ND STREET, SUITE 4000, NEW YORK, NY, 10168, US

(21) Appl. No.: 10/497,042

(22) PCT Filed: Jul. 15, 2003
(86) PCT No.: PCT/EP03/07647

(30) Foreign Application Priority Data
Sep. 28, 2002 (DE) 102-45-417.5

(51) Int. Cl. B29D 23/00; B29C 53/48

(52) U.S. Cl. 156/203; 156/218; 156/251; 156/267; 156/466; 156/515

(57) ABSTRACT

In order to further develop a method for producing tubular films that can be applied to an article as well as an apparatus for performing such a method, so that the complexity of production management aspects during production of tubular films is minimized and at the same time there is little material waste, the following arrangement is suggested: at least one pre-folding station for upwardly folding each of the two lateral regions of the film web along a respective bending edge that extends in the direction of travel of the film web; at least one flattening station for largely symmetrically pressing the two upwardly folded lateral regions on the central region of the film web; and, at least one welding station for forming the tubular film by means of welding the respective lateral region, in particular near the respective lateral edge, and the part of the central region spatially associated with the respective lateral region.

### BACKGROUND OF THE INVENTION

The present invention relates to a method for producing tubular films that can be applied to an article, in particular in the form of separable sleeve labels that can be applied to bottles, from a film web, wound for instance on a supply roller or core, with two lateral regions, each facing the respective lateral edge of the film web, and with one central region situated between the two lateral regions.

The present invention furthermore relates to an apparatus for performing such a method, that is, for producing tubular films that can be applied to an article, in particular in the form of separable sleeve labels that can be applied to bottles, from a film web, wound for instance on a supply roller or core, with two lateral regions facing respective lateral edges of the film web and with one central region situated between the two lateral regions.

Tubular films that can be applied to articles always enjoy great popularity, because, due to their embodiment surrounding the article, such tubular films offer a relatively large amount of space for product information about the article or its contents and/or advertisements.

Thus such tubular films, for instance in the form of so-called sleeve labels, are being employed with increasing frequency for beverage bottles, not only to list ingredients and product information, but also to convey bonus offers and marketing information.

In the past, however, the production management aspects were relatively complex during production of such tubular films. In this regard, for instance, one factor was that the starting material for the tubular films, normally a film web with two lateral regions facing a respective lateral edge of the film web and with one central region situated between the two lateral regions, had to be welded with at least one lateral seam for forming the tubular shape.

Also, there was normally a relatively large amount of film waste during production of such tubular films, which was counterproductive both ecologically and with respect to attempts to reduce costs; thus, solutions in accordance with prior art conflicted with the trend that has been underway for some time—to achieve savings with packaging.

### SUMMARY OF THE INVENTION

Starting with the disadvantages and deficiencies described in the foregoing, and having evaluated the clearly defined prior art, the object of the present invention is to further develop a method of the type cited in the foregoing and an apparatus of the type cited in the foregoing such that the complexity of production management aspects during production of tubular films is minimized and at the same time there is little material waste.

This object is achieved in a method in accordance with the preamble to the main claim in that in accordance with the teaching of the present invention:
(i) first in at least one pre-folding station each of the two lateral regions of the film web is upwardly folded along a respective bending edge extending in the direction of travel of the film web;
(ii) then in at least one flattening station the two upwardly folded lateral regions are pressed largely symmetrically on the central region of the film web; and,
(iii) then in at least one welding station the respective tubular film is formed from the respective lateral region and from the part of the central region facing the respective lateral region in that the respective lateral region, in particular near the respective lateral edge, and the spatially associated part of the central region are welded, in particular by means of hot air welding and/or high frequency welding and/or laser welding and/or thermal welding.

The aforesaid object is furthermore achieved in an apparatus in accordance with the preamble to the main claim in that this apparatus is characterized in accordance with the teaching of the present invention by:
at least one pre-folding station for upwardly folding each of the two lateral regions of the film web along a respective bending edge that extends in the direction of travel of the film web;
at least one flattening station for largely symmetrically pressing the two upwardly folded lateral regions on the central region of the film web; and,
at least one welding station for forming the tubular film by means of welding the respective lateral region, in particular near the respective lateral edge, and the part of the central region spatially associated with the respective lateral region.

A number of advantages that are not known with the prior art are associated with the method described in the foregoing and with the apparatus described in the foregoing for performing said method.

For instance, the production process makes possible simultaneous production of two tubular films, so that the user is afforded dual use while minimizing the resultant waste due to the symmetrical upward folding in the pre-folding station and due to the subsequent flattening of the two lateral regions of the film web in the flattening station, in conjunction with the subsequent welding in the welding station, which is also symmetrical.

In this context, symmetrical processing of the material web “on its two sides” facilitates efficient use of film webs that are wider than those known in prior art; it also favorably ensures cleaner exterior dimensions, defined by the bending edges, and better guiding of the material web during the technical production processes than for narrower material webs, which can minimize the risk of costly production down-times.

In addition, with the present method and with the present apparatus very thin film webs can be employed, which leads to significant savings in materials; also, as a rule thin material webs are completely adequate, especially for sleeve labels; for instance, in the case of sleeve labels for beverage bottles the primary issue is transporting information, rather than protecting the bottle or its contents.

In accordance with one preferred embodiment of the present invention, the pre-folding station has at least one pre-folding roller or core, the width of which is less than the width of the film web, so that symmetrical upward folding of the two lateral regions of the film web along the respective folding edge that extends in the direction of travel of the film web, and thus the position of the two folding edges, is defined by the two exterior edges of the pre-folding roller or core.

In one advantageous further development of the present invention, the flattening station has at least one largely planar plate, for instance made of sheet metal,
the width of which is approximately equal to the width of the pre-folding roller or core,
at the one surface of which the central region can pass, and
at the other surface of which the two lateral regions can be pressed with force in the direction of the central region by means of at least one pressure means, in particular by means of at least one in particular adjusted pressure roller or core.

With such an embodiment of the flattening station, the upwardly folded lateral regions of the material web are drawn inward and, in preparation for the desired tubular shape, can conform to the plate such that a highly symmetrical film material structure results even in advance of the welding station.

In accordance with one preferred embodiment of the present invention, vibrations and/or tensions in the film web provided with the two upwardly folded lateral regions that are pressed on the central region can be compensated in at least one buffer station interposed in particular between the flattening station and the welding station.

In order to compensate in this manner vibrations and/or tension problems in the material arc processed in the pre-folding station and in the flattening station, the buffer station advantageously comprises a plurality of compensation rollers or cores that are arranged offset to one another, at least some of which are movable. This in particular vertical mobility of the compensation rollers or cores can almost completely prevent difficulties during transport of the material web.

Largely the same purpose, that is, problem less transport of the film web, is served by the control table, by means of which the film web provided with the two upwardly folded lateral regions that are pressed onto the central region, in particular prior to welding, can be usefully laterally controlled; not the least this lateral control option makes it possible to position precisely the material web processed in the pre-folding station and in the flattening station for traversing the welding station.

In accordance with one useful further embodiment of the present invention, the welding station has at least two welding cambers or welding sickles, which can be arranged symmetrically to the film web and which can be positioned in the vicinity of the two upwardly folded lateral regions that are pressed on the center region, and by means of which hot air welding and/or high frequency welding and/or laser welding and/or thermal welding can be performed.

Therefore, the welding station functions to a certain extent as a double-welding station by means of which the two tubular films can be formed simultaneously in that the respective lateral region, in particular in the vicinity of the respective lateral edge, and the respective spatially associated part of the central region are welded; a film web remainder, to be removed subsequently, especially by evacuation, is formed between the two welded seams formed in this manner by means of the two welding cambers or welding sickles.

Thus, once the film web has passed through the welding station and hereby the two tubular films and the film web remainder remaining between the two tubular films have been created, this film web remainder can be conveniently evacuated, for instance upward, that is, in a direction away from the two tubular films, by means of at least one evacuation station, in particular downstream of the welding station, and thus can be removed in a reliable manner that does not hinder the production process.

Once this film web remainder has been removed for waste, each of the tubular films formed can be received in at least one respective storage unit, in particular in at least one respective exchangeable container, in a loose zigzagged stack. Not only can such a zigzagged stack avoid tension problems in the produced tubular film, but also an air column that in accordance with experience occurs in a tubular film when pulled off via at least one pair of cores can be pushed downward, which represents another advantage of the present invention for the user (in accordance with the prior art, it was necessary to embody such take-off cores or rollers differently and to drive them differently, which rendered the production process substantially more complicated and expensive).

Additional advantageous embodiments and additional useful further developments of the present invention are characterized in the dependent claims.

Finally, the present invention relates to a novel tubular film that can be applied to an article, in particular a novel sleeve label that can be applied to a bottle, produced in accordance with the method described in the foregoing and/or by means of at least one apparatus of the type described in the foregoing.

As already explained in the foregoing, there are various options for embodying and further developing the teaching of the present invention in an advantageous manner. Additional designs, features, and advantages of the present invention are explained in greater detail in the following using the exemplary implementation in accordance with one exemplary embodiment illustrated in FIGS. 1A through 3D.

### BRIEF DESCRIPTION OF THE DRAWINGS

FIG. 1A is a side elevation of a first section of one exemplary embodiment of an apparatus in accordance with the present invention for performing a method in accordance with the present invention;

FIG. 1B is a side elevation of a second section of an exemplary embodiment of an apparatus in accordance with the present invention that connects to the first section (see FIG. 1A);

FIG. 2A is a top view of the first section (see FIG. 1A) of the apparatus in FIGS. 1A and 1B;

FIG. 2B is a top view of the second section (see FIG. 1B) of the apparatus in FIGS. 1A and 1B;

FIG. 3A is a side elevation of an exemplary embodiment of a film web, in its starting condition, that constitutes the carrier material for the tubular films to be produced;

FIG. 3B is a side elevation of the film web in FIG. 3A after passing through a first process step allocated to a pre-folding station;

FIG. 3C is a side elevation of the film web in FIGS. 3A and 3B after passing through a second process step allocated to a flattening station;

FIG. 3D is a side elevation of the two tubular films, with the film web remainder therebetween, formed from the film web in FIGS. 3A, 3B, and 3C after passing through a third process step allocated to a welding station.

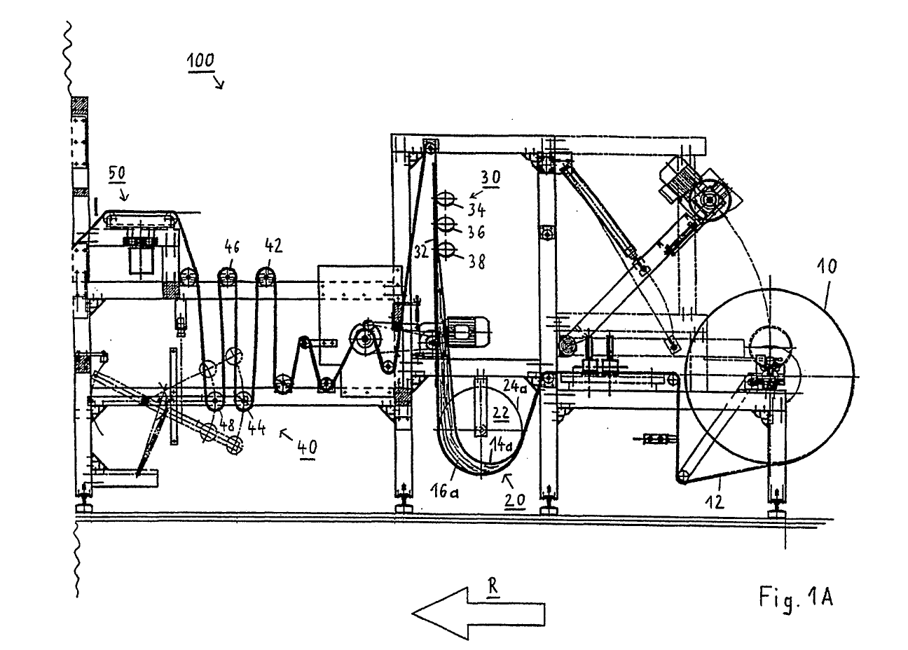

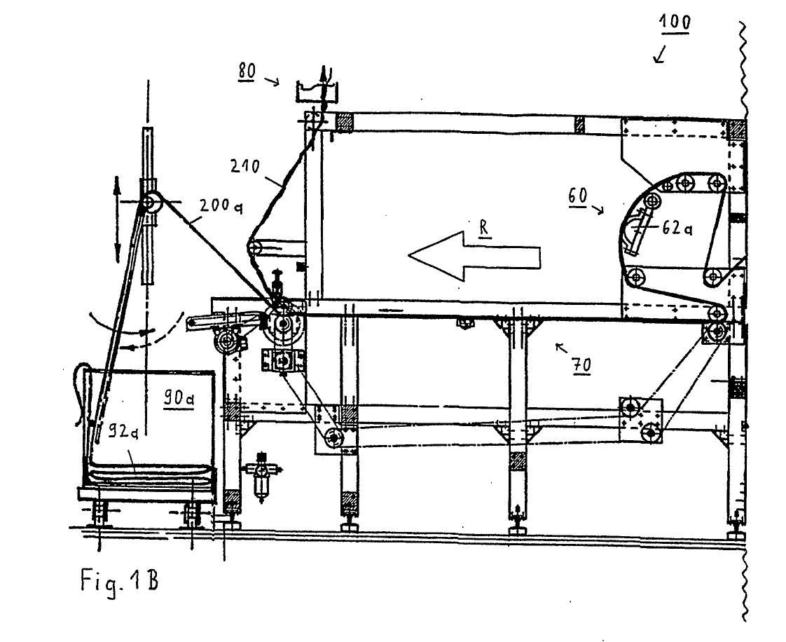

Identical reference numbers refer to the same or similarly embodied elements or features in FIGS. 1A through 3D.

### DETAILED DESCRIPTION OF THE INVENTION

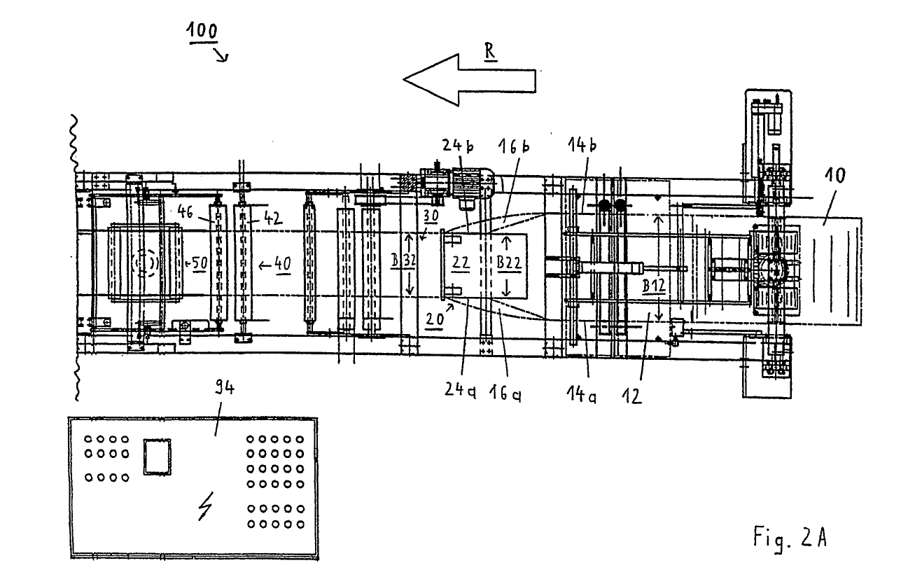

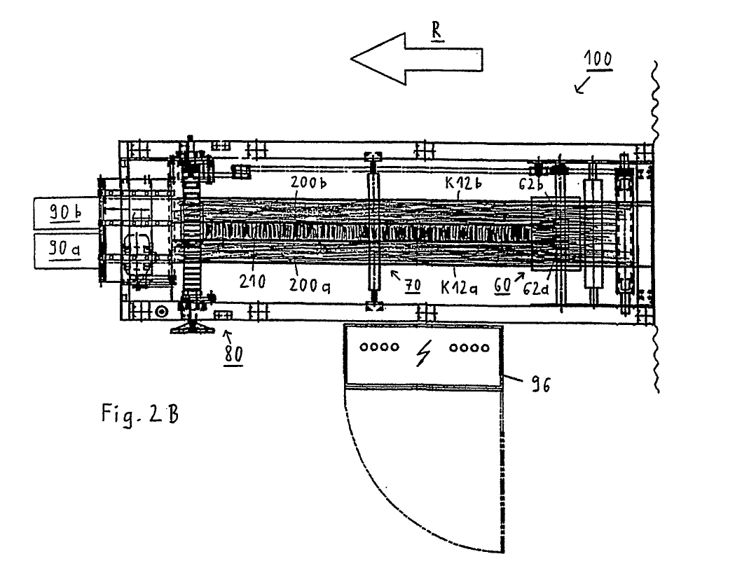

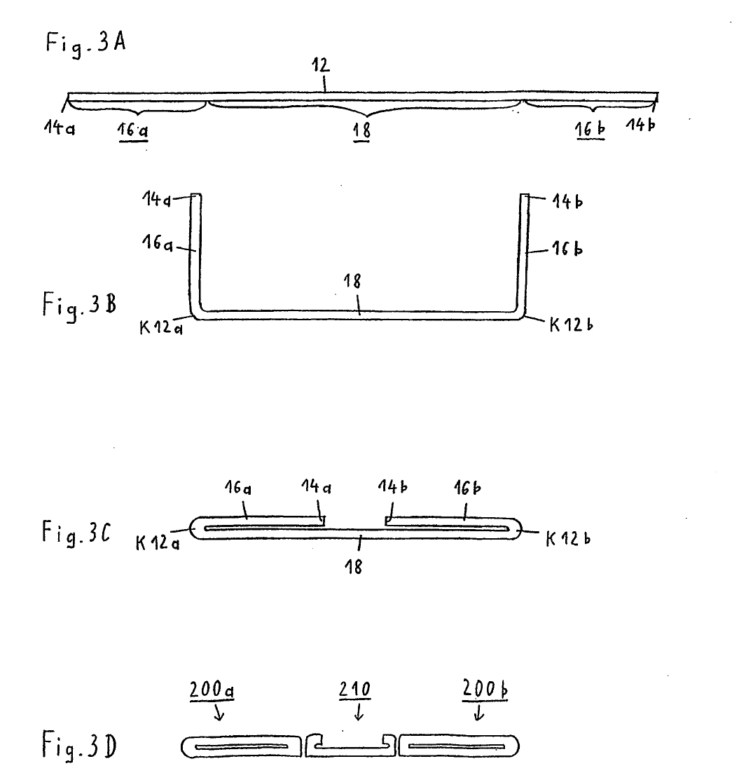

Illustrated in FIGS. 1A through 2B, the exemplary embodiment of an apparatus 100 controllable using two electrical consoles 94 and 96 (see FIG. 2A and FIG. 2B) in accordance with the present invention produces tubular films 200a, 200b (see FIG. 3D) in the form of sleeve labels that in their separated condition are applied to articles such as beverage bottles.

These tubular films 200a, 200b are produced from a film web 12 wound on a supply roller or core 10 (see FIGS. 1A and 2A), whereby this film web 12—shown in section in accordance with FIG. 3A—has two lateral regions 16a, 16b, facing the respective lateral edge 14a, 14b, and one central region 18 situated between the two lateral regions 16a, 16b.

Once the film web 12 is unwound from the supply roller or core 10, the film web 12 passes through a plurality of directional rollers or cores before it reaches a pre-folding station 20 (see FIGS. 1A and 2A). This pre-folding station 20 upwardly folds each of the two lateral regions 16a, 16b of the film web 12 along a respective bending edge K12a, K12b (see FIG. 3B) that extends in the direction of travel R of the film web 12.

For this purpose, the pre-folding station 20 has a pre-folding roller or core 22, the width B22 of which is less than the width B12 of the film web 12, so that the position of the two bending edges K12a, K12b is defined by the two exterior edges 24a, 24b of the pre-folding roller or core 22, as can be seen from FIG. 3B; in that illustration, the perpendicular distance between the upwardly folded or upwardly flipped lateral region 16a and the upwardly folded or upwardly flipped lateral region 16b is exactly the width B22 of the pre-folding roller or core 22.

After the pre-folding station 20, the processed material web 12 is transported “up” to a flattening station 30 (see FIGS. 1A and 2A). This flattening station 30 presses the two upwardly folded lateral regions 16a, 16b largely symmetrically on the central region 18 of the film web 12 (see FIG. 3C).

For this purpose, the flattening station 30 has a largely planar plate 32, for instance made of sheet metal, the width B32 of which is approximately equal to the width B22 of the pre-folding roller or core 22. The central region 18 can pass by at one surface of the plate 32, the left-hand surface in FIGS. 1A and 2A; the two lateral regions 16a, 16b can be pressed with force at the other surface of the plate 32, the right-hand surface as illustrated in FIGS. 1A and 2A, in the direction of the central region 18 by means of pressure means 34, 36, 38 in the form of three adjusted pressure rollers or cores.

With such an embodiment of the flattening station 30, the upwardly folded lateral regions 16a, 16b of the material web 12 are drawn inward and, in preparation for the desired tubular shape, can conform to the plate 32 such that a highly symmetrical film material structure results, even in advance of the welding station 60 (see FIG. 3C), the exterior dimensions of which are produced cleanly, defined by the two bending edges K12a, K12b.

After passing through various reversing and/or stabilizing rollers or cores, the material web 12 that was processed and shaped in the pre-folding station 20 and in the flattening station 30 passes through a buffer station 40 interposed between the flattening station 30 and the welding station 60 for compensating vibrations and/or tensions that occur along the transport direction R in the film web 12 provided with the two upwardly folded lateral regions 16a, 16b that have been pressed on the central region 18.

For this purpose the buffer station 40 has a plurality of compensation rollers or cores 42, 44, 46, 48 that are arranged offset to one another, whereby the two compensation rollers or cores 42, 46 at the top in FIG. 1A are stationary and whereby the two compensation rollers or cores 44, 48 at the bottom in FIG. 1A are vertically movable, as illustrated in phantom. This vertical mobility of the compensation rollers or cores 44, 48 can almost completely prevent difficulties during transport of the material web 12.

Largely the same purpose, that is, problemless transport of the film web 12, is served by a control table 50 that is in advance of the welding station 60; the film web 12 reaches it after traversing a reversing roller or core and by means of it the film web 12 provided with the two upwardly folded lateral regions 16a, 16b that are pressed on the central region 18 can be laterally controlled prior to being welded; not the least this lateral control option makes it possible to position precisely the material web 12 processed in the pre-folding station 20 and in the flattening station 30 for traversing the welding station 60.

When the film web 12 coming from the control table 50 reaches the welding station 60 (for technical illustration reasons, in the drawings this corresponds to the transition from FIG. 1A to FIG. 1B and the transition from FIG. 2A to FIG. 2B), in the welding station 60 two welding cambers or welding sickles 62a, 62b that are arranged symmetrically to the film web 12 and that are positioned in the vicinity of the two upwardly folded lateral regions 16a, 16b that are pressed on the center region 18 engage the folded material web 12.

Therefore two tubular films 200a, 200b are formed in the welding station 60 in that the respective lateral region 16a, 16b, in particular in the vicinity of the respective lateral edge 14a, 14b and the part of the central region 18 spatially associated with the respective lateral region 14a, 14b are welded, whether by means of hot air and/or high frequency and/or laser and/or thermal welding.

Therefore, the welding station 60 functions to a certain extent as a double-welding station by means of which the two tubular films 200a, 200b can be formed simultaneously; furthermore, as can be seen from FIG. 3D, a film web remainder 210, to be removed subsequently by evacuation, is formed between the two welded seams.

Thus, once the film web 12 has passed through the welding station 60 and hereby the two tubular films 200a, 200b and the film web remainder 210 remaining between the two tubular films 200a, 200b have been created, the material structure passes a table-shaped transport station 70.

The film web remainder 210 is upwardly evacuated away from the end of this transport station 70 by means of an evacuation station 80 (see FIGS. 1B and 2B) and is thus removed in a reliable manner that does not hinder the production process.

Once this film web remainder 210 has been removed, finally each of the tubular films 200a and 200b can be received in a respective storage unit 90a and 90b in the form of respective exchangeable containers in a loose zigzagged stack 92a and 92b. Not only can such a zigzagged stack 92a or 92b avoid tension problems in the produced tubular film 200a and 200b, but also an air column that in accordance with experience occurs in a tubular film 200a, 200b when pulled off via at least one pair of cores can be pushed downward, which represents another advantage of the present invention for the user.

Nordenia Deutschland

Pacimex GmbH

### REFERENCE SYMBOLS

100 Apparatus
10 Supply roller or core
12 Film web
14a First lateral edge of film web 12
14b Second lateral edge of film web 12
16a First lateral region of film web 12
16b Second lateral area of film web 12
18 Central region of film web 12
20 Pre-folding station
22 Pre-folding roller or core of pre-folding station 20
24a First exterior edge of pre-folding roller or core 22
24b Second exterior edge of pre-folding roller or core 22
30 Flattening station
32 Plate of flattening station 30
34 First pressure means, especially first adjusted pressure roller or core
36 Second pressure means, especially second adjusted pressure roller or core
38 Third pressure means, especially first adjusted pressure roller or core
40 Buffer station
42 First compensation roller or core
44 Second compensation roller or core
46 Third compensation roller or core
48 Fourth compensation roller or core
50 Control table
60 Welding station
62a First welding camber or first welding sickle
62b Second welding camber or second welding sickle
70 Transport station
80 Evacuation station
90a First storage unit, especially first exchangeable container
90b Second storage unit, especially second exchangeable container
92a Loose zigzagged stack in the first storage unit 90a
92b Loose zigzagged stack in the second storage unit 90b
94 First electrical console
96 Second electrical console
200a First tubular film, especially first sleeve label
200b Second tubular film, especially second sleeve label
210 Film web remainder
B12 Width of film web 12
B22 Width of pre-folding roller or core 22
B32 Width of plate 32
K12a Bending edge of first lateral region 16a
K12b Bending edge of second lateral region 16b
R Direction of travel

1-14. (canceled)

15. Method of producing tubular films from a film web in roll form, the film web having two lateral edges, two lateral regions contiguous with the respective lateral edges and a central region between and contiguous with the lateral regions, comprising:
at at least one prefolding station upwardly folding the lateral regions to form respective bending edges extending in a direction of travel of said film web;
at at least one flattening station pressing the upwardly folded lateral regions substantially symmetrically onto the central region; and
at at least one welding station forming tubular films from the lateral regions and parts of the central region contiguous with the lateral regions by, proximate the lateral edges, welding the lateral regions to said parts of the central region.

16. Method according to claim 15, further comprising:
compensating vibrations and/or tensions in said film web by interposing a buffer station between the flattening station and the welding station.

17. Method according to claim 15 or 16, further comprising:
by means of at least one control table, laterally controlling the film web downstream from the flattening station and upstream from the welding station.

18. Method according to claim 15 or 16, wherein two substantially parallel tubular films are formed and a portion of the central region between the two tubular films is not formed into the tubular films and further comprising:
at an evacuation station downstream from the welding station, evacuating said portion.

19. Method according to claim 15 or 16, further comprising:
collecting the tubular films in at least one exchangeable storage container by laying the tubular films in the storage container in a zigzag configuration

20. Apparatus for producing tubular films from a film web in roll form, the film web having two lateral edges, two lateral regions contiguous with the respective lateral regions and a central region between and contiguous with the lateral regions, comprising:
at least one prefolding station for upwardly folding the lateral regions to form respective bending edges extending in a direction of travel said film web;
at least one flattening station for pressing the upwardly folded lateral regions substantially symmetrically onto the central region; and
at least one welding station for forming tubular films from the lateral regions and parts of the central region contiguous with the lateral regions by, proximate the lateral edges, welding the lateral regions to said parts of the central region.

21. Apparatus according to claim 20, wherein:
the pre-folding station comprises at least one pre-folding roller or core having a width less than the width of the film web, the width of the rubber or core being defined by a distance between exterior lateral edges thereof, whereby positions of the bending edges of the film web are defined by said exterior lateral edges.

22. Apparatus according to claim 20 or 21 wherein:
the flattening station comprises at least one substantially planar plate of width at least substantially equal to the width of the pre-folding roller or core; and
means for pressing the upwardly folded lateral regions of the film web substantially symmetrically onto the central region of the film web while the central region of the film web is supported by a face of the plate; and
means for thereafter guiding the pressed film web over and spaced from the other face of the plate.

23. Apparatus according to claim 20 or 21, wherein:
the welding station comprises at least two welding cambers or sickles, the welding cambers being arranged symmetrically to the film web in the respective vicinities of the respective upwardly folded lateral regions of the film web.

24. Apparatus according to claim 20 or 21, further comprising:
a buffer station between the flattening station and the welding station for compensating vibrations and/or tensions in the pressed film web, the buffer station comprising a plurality of compensation rollers or cores arranged to offset one another and at least some of which are movable.

25. Apparatus according to claim 20 or 21, further comprising:
at least one control table downstream from the flattening station and upstream from the welding station for laterally controlling the film web.

26. Apparatus according to claim 20 or 21, further comprising:
an evacuation station downstream from the welding station for evacuating a portion of the central region of the film web which has not been formed into a tubular film.

27. Apparatus according to claim 20 or 21, further comprising:
at least one exchangeable container; and
means for laying the tubular films in the storage container in zigzag pattern.

28. A tubular film in which is a product of the method of claim 15 or 16.
